(19) United States
(12) Patent Application Publication
(10) Pub. No.: US 2006/0109647 A1
(43) Pub. Date: May 25, 2006

(54) Solar energy lamp

(76) Inventor: Zi Hui Liu, Guangzhou (CN)

Correspondence Address: LIBERTY PATENT AND TRADEMARK OFFICE, P.O. BOX 590, TAICHUNG CITY, 400, TW

(21) Appl. No.: 10/992,719

(22) Filed: Nov. 22, 2004

(51) Int. Cl. F21L 4/08

(52) U.S. Cl. 362/183

(57) ABSTRACT

A solar energy lamp, particularly a solar energy lamp capable of satisfying user's satisfaction in case of insufficient lighting, comprising solar energy batteries, a circuit board, a dry battery and a light emitting diode that is electrically connected to a circuit board. The circuit board includes a power circuit, a light-controlled circuit and a manual control circuit; wherein, the power circuit includes a diode D1 forming a circuit with solar energy batteries and the dry battery; the light controlled circuit includes a function conversion switch K2, a light sensitive resistor CDS, a resistor R2, and a transistor Q1; the manual control circuit includes a power switch K1, a function conversion switch K2, a resistor R2 and a transistor Q1. When sunlight is sufficient, the solar energy batteries will take up solar energy and convert it into electrical energy and store it for future use. When sunlight is insufficient, the dry battery is used to supply power, so that the invention is capable of satisfying user's requirements where lighting is insufficient.

### FIELD OF THE INVENTION

The present invention relates to a lighting fixture could either be a solar energy lamp by using a rechargeable battery charged by solar cells or a battery lamp by adopting a non-rechargeable battery.

### DESCRIPTION OF THE PRIOR ART

The solar energy lamp uses solar energy cells to convert sunlight to electrical energy and store it in a rechargeable battery, for future use at nighttime. Generally, a solar energy lamp is designed to include a rechargeable battery to store more electrical energy during daytime when sunlight is more than sufficient, for a more extended use at nighttime, lasting even to eight hours of lighting. In cloudy, rainy and winter days when there is not enough sunlight, less electrical energy will be stored in the rechargeable battery, therefore the lighting time of the solar energy lamp is significantly reduced. That is a shortcoming frequently experienced by users.

### SUMMARY OF THE INVENTION

The object of this invention is to provide a type of solar energy lamp, which is capable of converting power source to provide sufficient power to satisfy user's requirements, especially where sunlight is not enough to enable proper storage of electrical energy in a rechargeable battery.

According to the object and performance of the present invention, the solar energy lamp comprises a top cover, a battery compartment, a frosted hood, a small square frame, a large square frame, solar energy batteries, a circuit board, regular batteries and a light emitting diode connected electrically to the circuit board.

The battery compartment is attached to the top cover, having battery grooves. The battery grooves accommodate solar energy rechargeable batteries or regular dry batteries; the light emitting diode is installed in the light penetrable frosted hood; the frosted hood is fitted and fastened inside the small square frame; the small square frame is fitted and fastened inside the large square frame; the large square frame is assembled with the battery compartment.

The circuit board includes: a power circuit, a light-controlled circuit and a manual control circuit. The power circuit includes a diode D1 that is integrated in a loop with the solar energy batteries and the regular batteries; the light-controlled circuit consists of a function conversion switch K2, a light sensitive resistor CDS, a resistor R2, and a transistor Q1; the manual control circuit consists of a main power switch K1, a function conversion switch K2, a resistor R2 and a transistor Q1.

Compared with the conventional technology, in regular use, the present invention uses rechargeable batteries. When the main power switch and the function conversion switch are switched ON, the invention works like a regular solar energy lamp in outdoors use. When sunlight is insufficient and needs to put the lamp to indoors or outdoors use, the function of the rechargeable batteries can be switched to the dry batteries, when the main power switch and the function conversion switch are switched ON.

Therefore, the solar energy lamp can be controlled automatically by sunlight, or the function conversion switch can be switched OFF to permit manual control of main power switch and the solar energy lamp; thereby, when the lamp is not in use, its power can be switched off to save energy. On one hand, the lamp can be used in a special environment where sunlight is sufficient; on the other hand, the lamp can also be used in another environment where sunlight is insufficient. The present invention has a wide range of applications to satisfy user's requirements in different circumstances.

### BRIEF DESCRIPTION OF DRAWINGS

In order that the present invention may more readily be understood, the following description is given, merely by way of example with reference to the accompanying drawings, in which:

FIG. 1 is a perspective view of the present invention.

FIG. 2 is an assembly view of the invention showing a hanging ring, a top cover, a battery compartment, solar energy batteries, a battery cover, a light emitting diode and a plastic tube.

FIG. 3 is a perspective view of the hanging ring in the invention.

FIG. 4 is a perspective view of the top cover in the invention.

FIG. 5 is a perspective view of the battery cover in the invention.

FIG. 6 is an assembly view of the invention showing a frosted hood, a small square frame and a large square frame.

FIG. 7 is a perspective view of the frosted hood.

FIG. 8 is a perspective view of the small square frame in the invention.

FIG. 9 is a perspective view of the large square frame in the invention.

FIG. 10 is a circuit diagram of the invention.

### DESCRIPTION OF THE PREFERRED EMBODIMENT

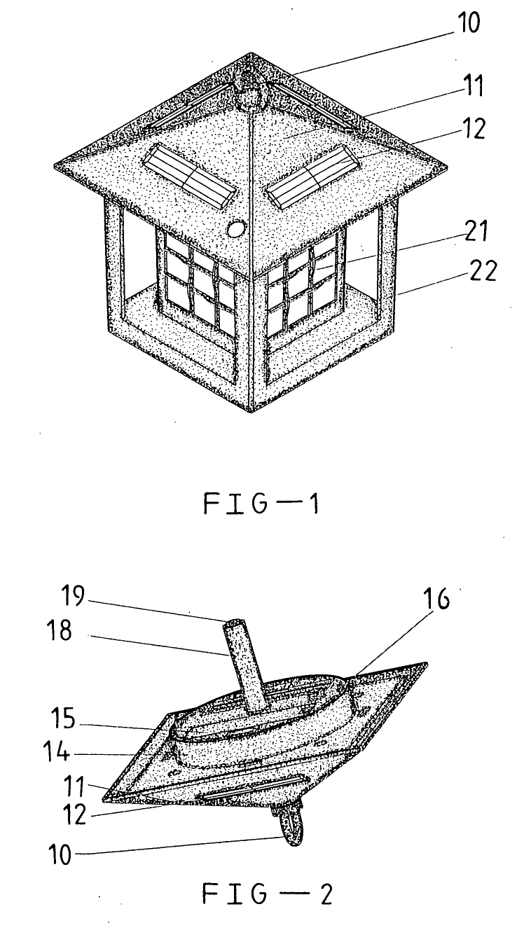

Please refer to FIG. 1 that shows the exterior of the present invention including the following components: a hanging ring 10, a top cover 11, a plurality of solar energy batteries 12, a small square frame 21 and a large square frame 22.

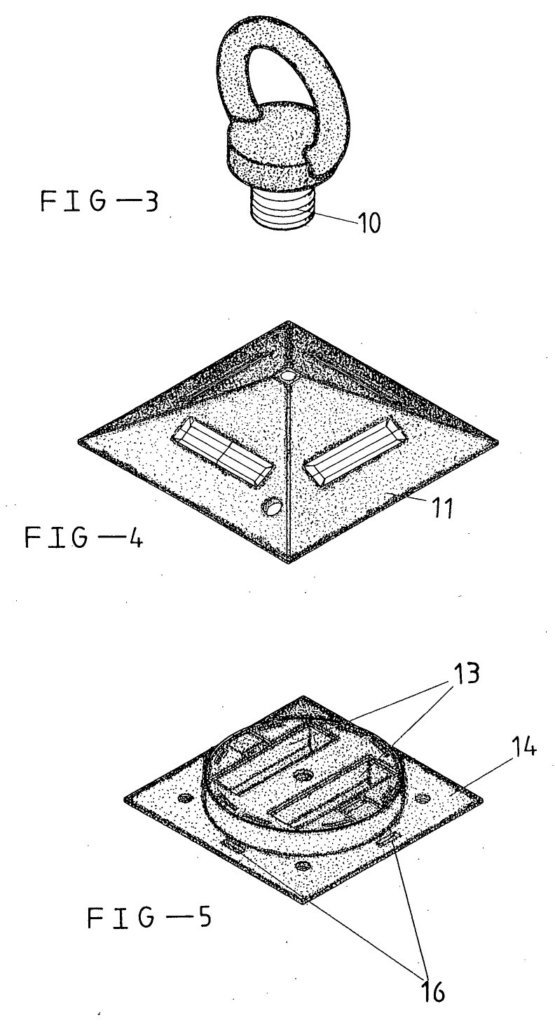

As shown in FIGS. 1, 3 and 4, the hanging ring 10 and the top cover 11 are tightened by screws, and the solar energy batteries 12 are glued to the top cover 11. As shown in FIG. 2, a battery compartment 14 is assembled to the bottom side of the top cover 11. The battery compartment 14 and the top cover 11 are joined and fastened by tightened optionally by screw bolts.

As shown in FIG. 5, the battery compartment 14 includes two battery grooves 13. A circuit board (not shown in drawing) is tightened by screw bolts onto the rear side of the battery compartment 14, the circuit on the circuit board is electrically connected to the two battery grooves 13.

As shown in FIG. 2, the battery cover 15 is installed and snapped tight on the battery compartment 14 to protect the batteries contained in the battery compartment 14, keeping the batteries from loosening. The light emitting diode 19 is electrically connected to the circuit board (not shown in drawing), with a cream-white plastic tube enclosing the periphery of the light emitting diode 19. The light emitting diode 19 emits flickering light, like a candle. When the top cover 11 and the assembly of battery compartment 14 are assembled with the other components, the cream-white plastic tube 18 and the light emitting diode 19 are accommodated inside the frosted hood 20.

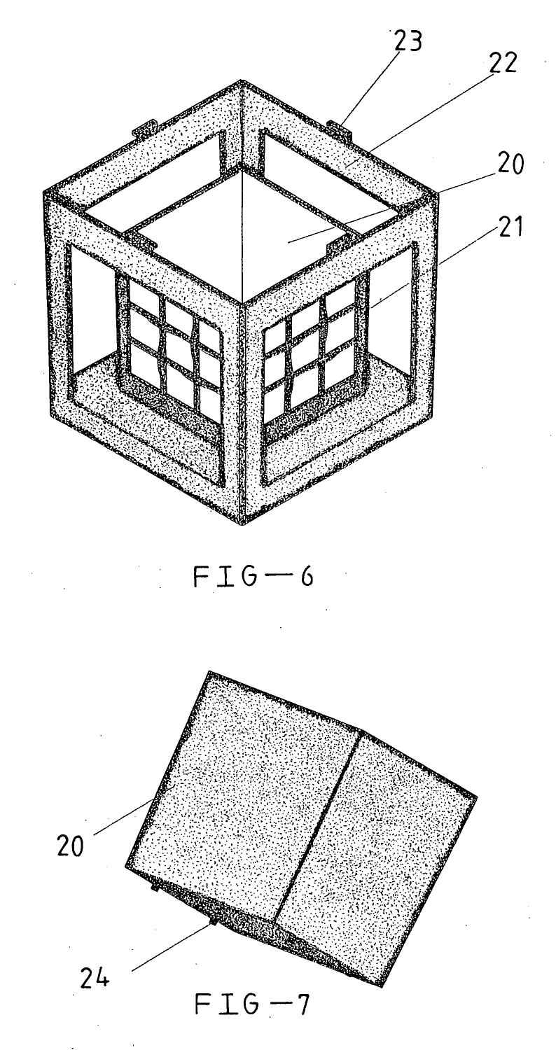

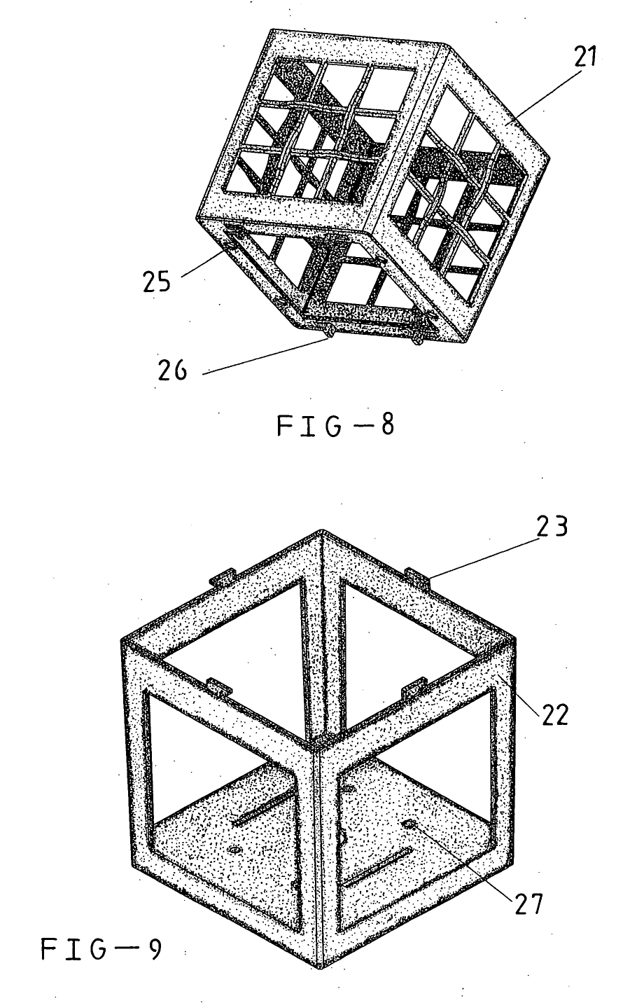

As shown in FIG. 6, the light penetrable frosted hood 20 is installed inside the small square frame 21. As shown in FIGS. 7 and 8, the bottom of the frosted hood 20 has four pieces of positioning posts 24 inserted into four positioning holes 25 on the bottom of the small square frame 21, thereby joining the frosted hood 20 to the small square frame 21.

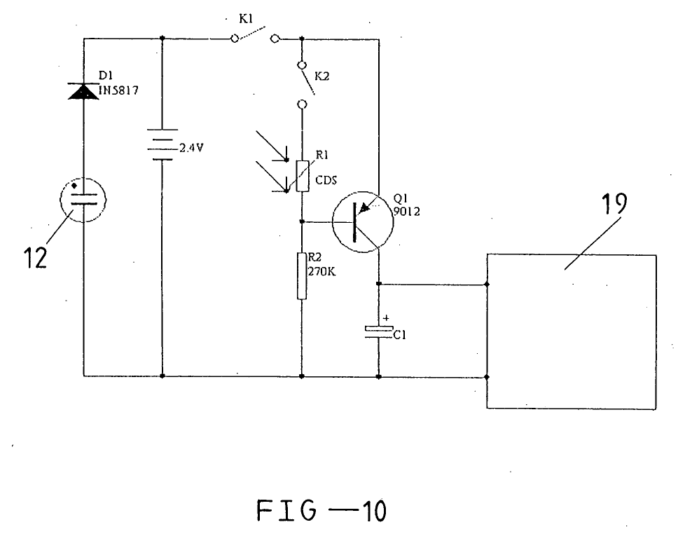

As shown in FIG. 6, the small square frame 21 is installed inside and joined to the large square frame 22 to become one unit. As shown in FIGS. 8 and 9, the bottom of the small square frame 21 has four snap members 26 that are joined and fastened to snap members 27 on the bottom of the large square frame 22.

Please refer to FIGS. 5 and 9; at the middle of each four sides of top the large square frame 22 there has four snap members 23. After the snap members 23 are inserted into four snap members 16 on the battery compartment 14 which is turned in clockwise direction and fastened into position.

As shown in FIG. 10, the circuit board includes a power circuit, a light-controlled circuit and a manual control circuit, of which:

The power circuit includes a diode D1; the diode D1 is integrated in a circuit with the solar energy batteries 12.

The light-controlled circuit consists of a function conversion switch K2, a light sensitive resistor CDS, a resistor R2, and a transistor Q1.

The manual control circuit consists of a power switch K1, a function conversion switch K2, a resistor R2 and a transistor Q1. In regular circumstances, the batteries are rechargeable batteries.

In daytime with sufficient sunlight, the solar energy batteries 12 convert the solar energy into electrical energy that passes through the diode D1 to charge the rechargeable batteries. When the power switch K1 and function conversion switch K2 are switched on, the circuit in the circuit board is activated, and the circuit status is consistent with a regular solar energy lamp. When the circuit's power switch K1 is switched off, the light emitting diode 19 will not work, regardless of whether the function conversion switch K2 is on or off.

In winter season or cloudy or rainy days without sufficient lighting, the charging volume to the solar energy batteries is very small, so the user cannot be sure of how long a time the solar energy lamp will work. In that case, the user can switch from rechargeable batteries to regular dry batteries to supply power directly to the light emitting diode 19, thereby the solar energy lamp becomes a battery lamp. It works as follows:
1. When the function conversion switch K2 is switched ON, the light-sensitive resistor CDS is activated. In this mode, the user can have automatic control by switching ON the circuit's power switch K1. In daytime when there is sunlight, reduced light-sensitive CDS value will result in increased voltage drop of the resistor R1, when the transistor Q1 stops the passage of current, and the light emitting diode 19 does not work; at nighttime, increased resistance of the light-sensitive resistor CDS result in decreased voltage drop of the resistor R1, when the transistor Q1 enables the current to pass, and the light-emitting diode 19 starts to work. The above working principle is similar to the solar energy lamp, except that replacement is required when the batteries have run out.
2. When the function conversion switch K2 is switched OFF, the light-sensitive resistor CDS is disabled, and the light-emitting diode 19 switch is controlled manually; when the circuit's power switch K1 is switched ON, the circuit is conducted, then the voltage drop of the resistor RI is decreased, so the transistor Q1 is conducted, and the light-emitting diode 19 starts to work; when K1 is switched OFF, the circuit is cut off and the light-emitting diode 19 stops working.

I claim:

1. A solar energy lamp, capable of using solar energy batteries or regular batteries as power supply, comprising:
a top cover;
a plurality of solar energy batteries, installed on a surface of the top cover;
a battery compartment, assembled to a bottom side of the top cover, having battery grooves and a circuit board, the battery grooves being electrically connected with the circuit board;
a frosted hood that is light penetrable;
a small square frame, having a surrounding surface permitting light penetration, the frosted hood being installed inside the small square frame;
a large square frame, having a surrounding surface permitting light penetration, the small square frame being installed inside the large square frame, the top cover and the battery compartment being assembled and installed at a top part of the large square frame;
a light emitting diode, installed inside the frosted hood, electrically connected with the circuit board in the battery compartment;
the circuit further includes a power circuit, a light-controlled circuit and a manual control circuit, wherein:
the power circuit includes a diode, the diode being integrated in the circuit with the solar energy batteries and the batteries in battery grooves;
the light controlled circuit consists of a function conversion switch, a light sensitive resistor, a resistor and a transistor;
the manual control circuit consists of a circuit power switch, a function conversion switch, a resistor and a transistor;
by switching on or off the conversion switch, the user is capable of controlling the light-sensitive resistor, thereby capable of switching between auto control or manual control of the solar energy lamp.

2. The solar energy lamp of claim 1, wherein, the solar energy lamp further includes a hanging ring installed on a top of the top cover; the battery grooves being installed with a battery cover; a periphery of the light emitting diode being enveloped by a plastic tube.

3. The solar energy lamp of claim 1, wherein, the solar energy lamp further includes four positioning holes provided at a bottom of the small square frame, and four positioning posts on a bottom of the frosted hood being inserted into four positioning holes on the small square frame; the large square frame has four snap members on a bottom part thereof, to be snapped in position to four snap members on a bottom part of the small square frame; the battery compartment has four snap members, to be inserted in four snap members on the battery compartment.
